(19) United States
(12) Patent Application Publication
(10) Pub. No.: US 2008/0230066 A1
(43) Pub. Date: Sep. 25, 2008

(54) Perfume impregnated mask with an image thereon

(75) Inventor: Kapoor Chandaria, Nairobi (KE)

Correspondence Address: SAND & SEBOLT, AEGIS TOWER, SUITE 1100, 4940 MUNSON STREET, NW, CANTON, OH, 44718-3615, US

(73) Assignee: KITARU INNOVATIONS INC., Lascelles (BB)

(21) Appl. No.: 11/725,623

(22) Filed: Mar. 20, 2007

(51) Int. Cl. A62B 7/10

(52) U.S. Cl. 128/206.13

(57) ABSTRACT

A face mask for covering the nose and mouth of a healthcare professional. The mask is made from a material that is impregnated or coated with a pleasant smelling perfume. The mask may be impregnated with the perfume at the factory or, alternatively, may be sold with one or more perfume retaining dispensers which enable the professional to apply a desired quantity of perfume to the mask immediately prior to use. The mask of the present invention may also be provided with a child-appealing image thereon. The image may be applied at the factory by incorporating the same into the material from which the mask is made or by adhesively connecting the same thereto. Alternatively, the image may be in the form of an applique that is child-appealing in nature is adhesively or otherwise secured to the outer surface of the mask at the hospital or consulting room. The pleasant smelling perfume may also be applied to the applique.

### BACKGROUND OF THE INVENTION

1. Technical Field

This invention generally relates to apparel. More particularly, the invention relates to apparel for healthcare professionals such as doctors, nurses and dentists. Specifically, the invention relates to a face mask that is impregnated with a pleasant smelling perfume and may include a child-appealing image thereon.

2. Background Information

Healthcare professionals are frequently required to wear face masks during various medical and dental procedures. These masks are designed to protect both the patient and the healthcare professional by acting as a filter for bacteria. The masks also prevent particulate matter and bodily fluids generated during procedures from accidentally splashing onto the face of the healthcare professional. So, for example, in a dental office a dentist will wear a face mask to prevent saliva and particulate matter created during cleaning or drilling procedures from coming into contact with their face. In an operating room or in a hospital, nurses and doctors will wear masks to prevent bacteria they breathe out from coming into contact with patients who may have compromised immune systems.

The masks are effective for the purpose for which they have been designed. However, when the healthcare professional is dealing with certain health-related situations, odors from chemicals, medications or infections may make the healthcare professional feel nauseated. Furthermore, when dealing with young children, the site of a masked person may be extremely frightening to the young patient.

There is therefore a need in the art for a face mask that addresses one or both of these issues.

### SUMMARY OF THE INVENTION

The device of the present invention is a face mask that is designed to cover the nose and mouth of the healthcare professional. The mask is made from a material that is impregnated or coated with a pleasant smelling perfume. The mask may be impregnated with the perfume at the factory or, alternatively, may be sold with a small dispenser of perfumed liquid which enables the professional to apply a desired quantity of perfume to the mask immediately prior to use. The mask of the present invention may also be provided with a child-appealing image thereon. The image may be applied at the factory by incorporating the same into the material from which the mask is made or by adhesively connecting the same thereto. Any one of a variety of appliques that are child-appealing in nature and which may be adhesively or otherwise secured to the outer surface of the mask may be applied thereto.

### BRIEF DESCRIPTION OF THE DRAWINGS

The preferred embodiments of the invention, illustrative of the best mode in which applicant has contemplated applying the principles, are set forth in the following description and are shown in the drawings and are particularly and distinctly pointed out and set forth in the appended claims.

FIG. 1 is a perspective view of a face mask known in the prior art shown worn by a healthcare professional;

FIG. 2 is a perspective view of the prior art face mask shown in FIG. 1;

FIG. 3 is a cross-sectional side view of the face mask taken through line 3-3 of FIG. 2;

FIG. 4 is a perspective view of a face mask in accordance with the present invention shown worn by a healthcare professional;

FIG. 5 is a perspective view of the face mask in accordance with the present invention;

FIG. 6 is a cross-sectional side view of the face mask taken through line 5-5 of FIG. 5;

FIG. 7 is a perspective view of a second embodiment of the face mask of the present invention; and

FIG. 8 is a perspective view of a third embodiment of the face mask in accordance with the present invention.

### DETAILED DESCRIPTION OF THE INVENTION

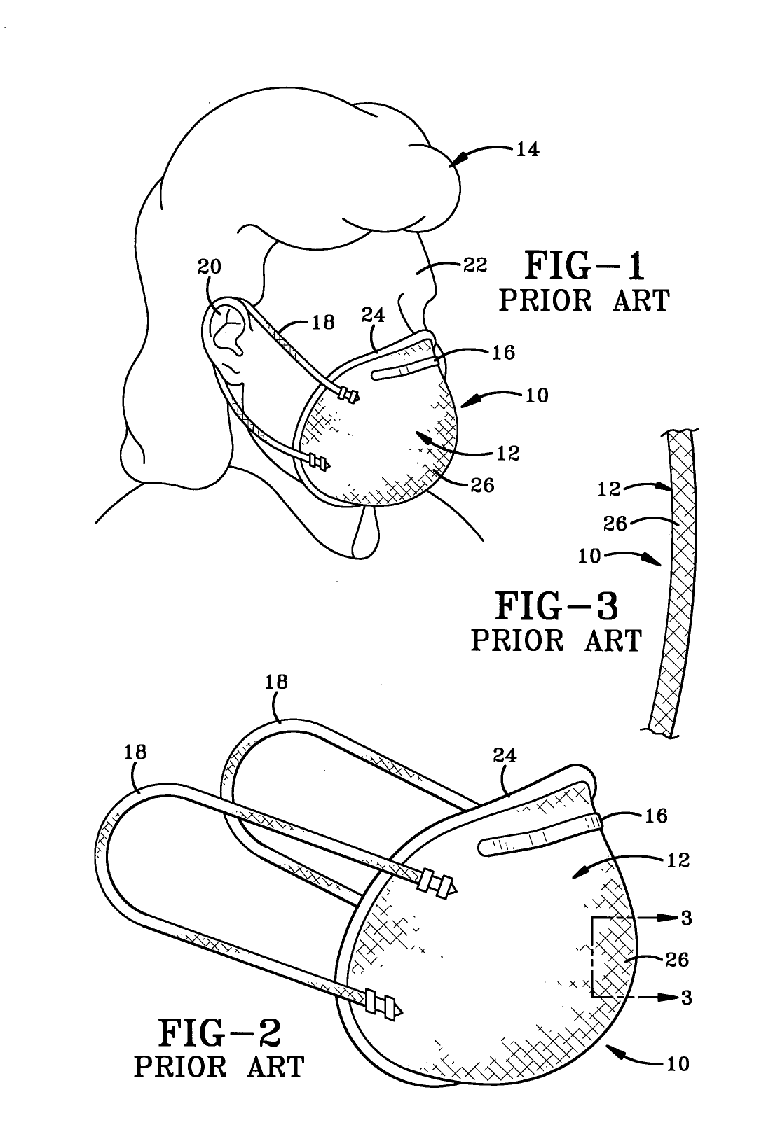

Referring to FIGS. 1-3, there is shown a face mask known in the prior art and being generally indicated at 10. Mask 10 includes a shield 12 that is able to placed over the mouth and nose of a healthcare professional 14. Shield 12 is provided with a nose clip 16 to tightly retain shield 12 against the nose of the professional 14. Shield 12 is also provided with a pair of ear-engaging connector members 18 that are passed around and behind the professional's ears 20 to retain shield 12 on the face 22. A rim 24 is provided around the perimeter of shield 12 to conform mask 10 to the contours of the professional's face 22. Shield 12 is manufactured from a fabric or material 26 that enables air to pass therethrough so that the professional 14 is able to breathe. The fabric 26 of shield 12 does not permit droplets of liquid to pass therethrough and can be made from a liquid absorbent or liquid impervious material.

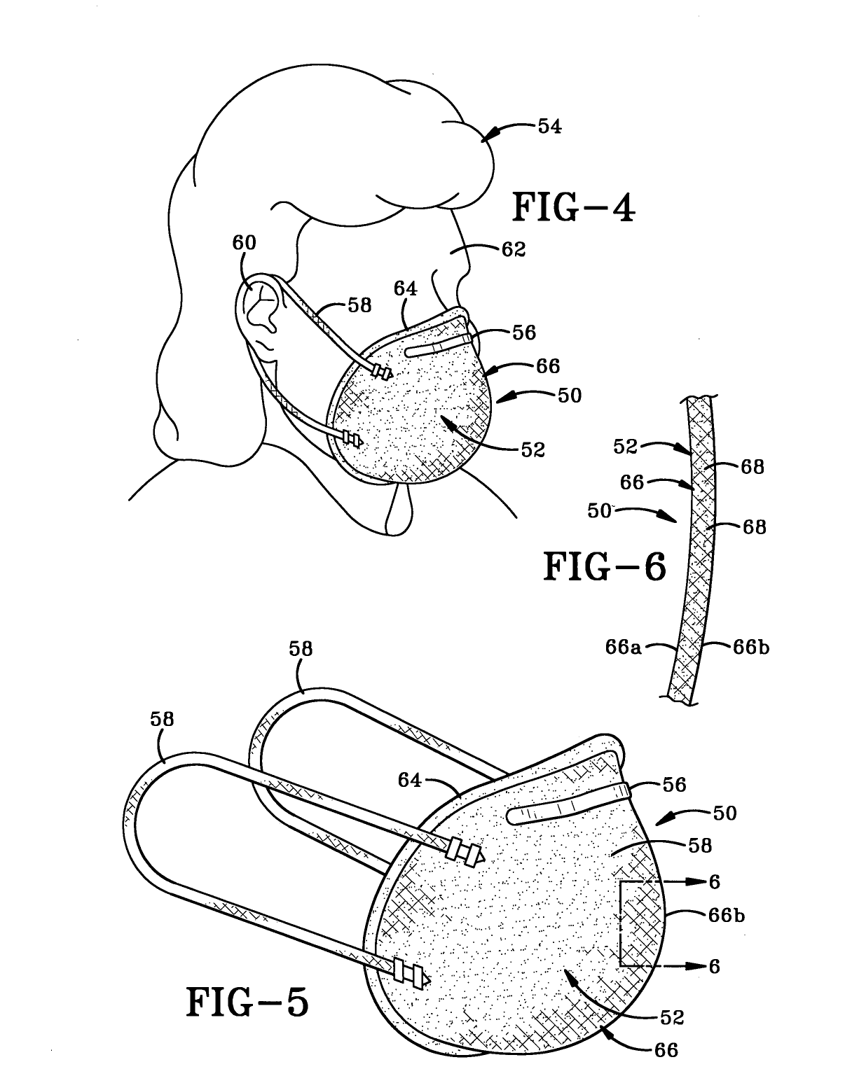

Referring to FIGS. 4-6 there is shown a face mask in accordance with the present invention and generally indicated at 50. Mask 50 includes a shield 52 that may be placed over the mouth and nose of a healthcare professional 54. Shield 52 is provided with a nose clip 56 to retain shield 52 tightly against the nose of the professional 54. Shield 52 is also provided with ear-engaging connector members 58 that are passed around and behind the professional's ears 60 to retain mask 50 on the face 62. While two connector members 58 are shown in the attached drawings, it will be understood that a single connector member such as a strap may be secured thereto to pass around the professional's head. A rim 64 is provided on the periphery of shield 52. Rim 64 conforms to the contours of the professional's face 62 to aid in retaining mask 50 thereon. Shield 52 is manufactured from a fabric or material 66 that enables air to pass therethrough so that the professional 54 is able to breathe. The fabric 66 of shield 52 does not permit droplets of liquid to pass therethrough and may be either liquid absorbent or liquid impervious.

In accordance with a specific feature of the present invention, fabric 66 of shield 52 is impregnated with a pleasant smelling perfume 68 as indicated by the stippling in FIGS. 4-6. Perfume 68 is applied to the fabric 66 in one of two ways. Firstly, fabric 66 may be substantially porous and, when immersed in a perfumed liquid, absorbs some of the same. Alternatively, the perfume 68 may be applied to fabric 66 by spraying a perfumed and aerosol-dispersed liquid onto the one of the interior and exterior surfaces 66a, 66b of mask 50. When mask 50 is worn by the healthcare professional 14, the perfume 68 slowly evaporates from fabric 66 and subsequently perfumes the air breathed in and out by the professional who wears of the mask 50. It will be understood that the perfumed liquid may be applied to the entire shield 52 or to just a portion of the same.

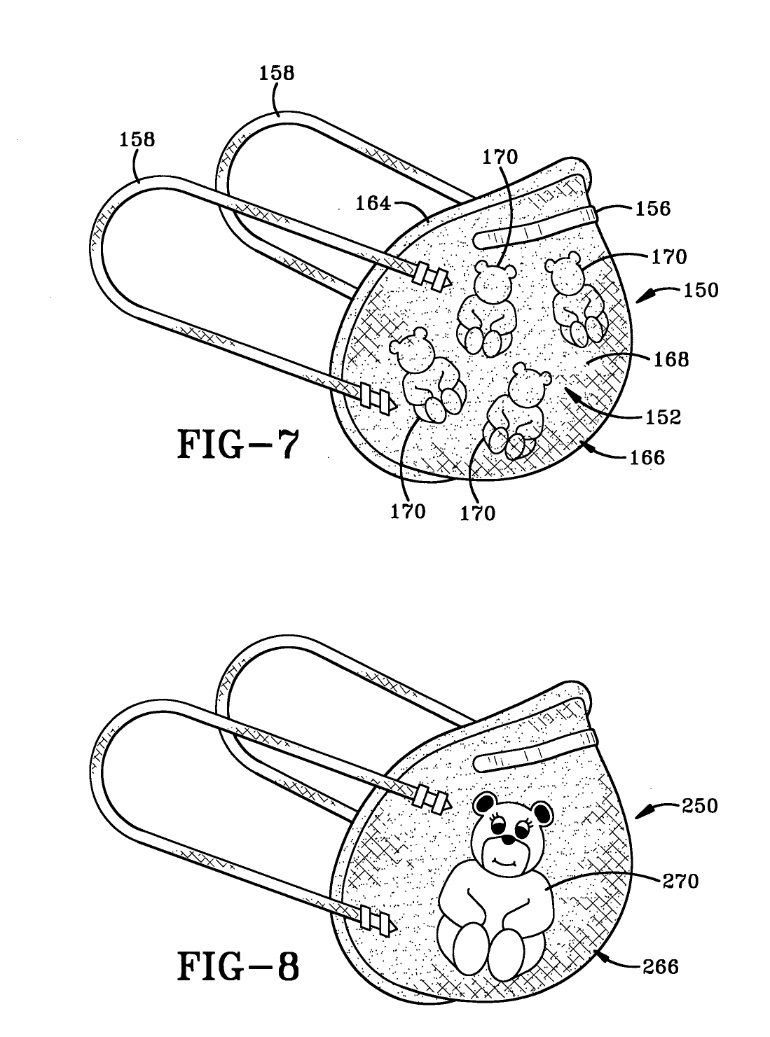

Referring to FIG. 7, there is shown a second embodiment of a face mask in accordance with the present invention and generally indicated at 150. Mask 150 includes a shield 152 that is placed over the mouth and nose of a healthcare professional. Shield 152 is provided with a nose clip 156 to retain shield 152 tightly against the nose of the professional. Shield 152 is also provided with ear-engaging connector members 158 that are to be passed around and behind the professional's ears to retain mask 150 on the face. A rim 164 is provided on shield 150 to conform to the contours of the professional's face and thereby to aid in retaining mask 150 thereon. Shield 152 is manufactured from a fabric or material 166 that enables air to pass therethrough so that the professional is able to breathe. The fabric 166 of shield 152 does not permit droplets of liquid to pass therethrough. As with the previous embodiment, fabric 166 is impregnated or coated with a pleasant smelling perfume 168 as indicated by the stippling in FIG. 7

In accordance with yet another feature of the present invention, the fabric or material 166 from which mask 150 is made preferably is imprinted with a plurality of child-pleasing images 170. Images 170 may take any form such as the bears illustrated in FIG. 7. It will be understood that images 170 may, alternatively, be applied by weaving the same into the fabric 166.

Referring to FIG. 8 there is shown a third embodiment of the mask of the present invention being generally indicated at 250. Mask 250 is provided with a single image 270 thereon, but instead of image 270 being imprinted into fabric 266, it is applied as an applique that is adhered to mask 250 by an adhesive or by a hook and pile type fastener (not shown). Image 270 may again take any form. So, for example, if a baby is being treated, the image 270 may be of a teddy bear, for a young boy the image may be a plane and for a young girl the image may be that of a princess. The appliqued images 270 may also be impregnated or coated with a perfume.

Masks 50, 150 and 250 preferably are disposable, but may also be manufactured from a fabric or material that may be laundered or sterilized in an appropriate manner.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A mask for covering the nose and mouth region of a healthcare professional's face, said mask comprising:
a shield made from a material that is air permeable and one of liquid impermeable and liquid absorbent;
a connector member for retaining the shield against the healthcare professional's face; and
a perfumed liquid applied to the material of the shield.

2. The mask as defined in claim 1, wherein the shield has an inner and an outer surface; and wherein the perfumed liquid is applied to one or both of the inner and outer surfaces of the shield.

3. The mask as defined in claim 1, wherein the perfumed liquid is impregnated into the material of the shield.

4. The mask as defined in claim 1, wherein the perfumed liquid is applied substantially over the entire shield.

5. The mask as defined in claim 1, wherein the perfumed liquid is applied in one or more discrete zones in the shield.

6. The mask as defined in claim 1, further comprising an image applied to the shield.

7. The mask as defined in claim 6, wherein the image is an applique that is applied to an outer surface of the shield.

8. The mask as defined in claim 6, wherein the shield is made from a woven fabric and the image forms part of the woven fabric.

9. The mask as defined in claim 6 further including at least a second image applied to the shield.

10. The mask as defined in claim 6, wherein the image is a child-pleasing image.

11. A mask for covering the nose and mouth region of a healthcare professional's face, said mask comprising:
a shield made from a material that is air permeable and one of liquid impermeable and liquid absorbent; and wherein said shield includes an interior surface, an exterior surface and has a thickness therebetween;
a connector member for retaining the shield against the healthcare professional's face;
a perfumed liquid applied to the material of the shield; and
at least one image applied to the material.

12. The mask as defined in claim 11, wherein the liquid is applied onto one or both of the interior and exterior surfaces of the shield.

13. The mask as defined in claim 11, wherein the liquid is impregnated into the material of the shield and is retained in the material between the interior and exterior surfaces thereof.

14. The mask as defined in claim 11, wherein the at least one image is formed as an integral part of the material of the shield.

15. The mask as defined in claim 11, wherein the at least one image is an applique that is applied over the exterior surface of the shield.

16. The mask as defined in claim 11, wherein the at least one image is a child pleasing image.

17. The mask as defined in claim 11, wherein the perfumed liquid is further applied to the image.
